(19) United States
(12) Patent Application Publication
(10) Pub. No.: US 2013/0073368 A1
(43) Pub. Date: Mar. 21, 2013

(54) INCENTIVIZING PHYSICAL ACTIVITY

(71) Applicant: Blake Squires, Akron, OH (US)

(72) Inventor: Blake Squires, Akron, OH (US)

(21) Appl. No.: 13/356,901

(22) Filed: Jan. 24, 2012

Related U.S. Application Data
(60) Provisional application No. 61/535,578, filed on Sep. 16, 2011.
(60) Provisional application No. 61/537,604, filed on Sep. 22, 2011.

(51) Int. Cl. G06Q 30/02

(52) U.S. Cl. 705/14.26; 705/14.1

(57) ABSTRACT

Systems and methods that incentivize physical fitness of a user are discussed herein. In one embodiment, such a system can include a motion component and a control component. The motion component can monitor motion data associated with the user. The control component can provide one or more rewards to the user, wherein the rewards can be based at least in part on the user meeting a target associated with the motion data.

### CROSS-REFERENCE TO RELATED APPLICATIONS

This application claims the benefit of U.S. Provisional Patent application Ser. No. 61/535,578 entitled “SYSTEM AND METHOD OF RECORDING DISTANCE AND CONTEST RELATED THERETO” and filed Sep. 16, 2011, and also claims the benefit of Ser. No. 61/537,604 entitled “SYSTEM AND METHOD OF RECORDING DISTANCE AND CONTEST RELATED THERETO” and filed Sep. 22, 2011. The entireties of the above-noted applications are incorporated by reference herein.

### BACKGROUND

Sufficient physical activity is an essential part of a healthy lifestyle, yet many individuals, for many different reasons, do not incorporate sufficient physical activity into their lifestyles. Numerous avoidable health problems result from insufficient physical activity, costing millions or more each year in preventable health care costs. Conventional systems and methods may provide tools to monitor levels of physical activity among those already engaging in physical activity. However, these systems and methods do not provide tools to help individuals incorporate physical activity into their lifestyles.

### SUMMARY

The following presents a simplified summary of the innovation in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

The innovation disclosed and claimed herein, in one aspect thereof, comprises a system that incentivize physical fitness of a user are discussed herein. In one embodiment, such a system can include a motion component and a control component. The motion component can monitor motion data associated with the user. The control component can provide one or more rewards to the user, wherein the rewards can be based at least in part on the user meeting a target associated with the motion data.

In another aspect of the subject innovation, it can comprise a method of facilitating physical activity of a user. Such a method can comprise the acts of creating a user account and determining an activity target of the user. Additionally, the method can include the step of monitoring user motion until the user meets the activity target. Also, the method can include the act of providing the user a reward based at least in part on meeting the activity target.

To the accomplishment of the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

FIG. 1 illustrates an example system that incentivize physical activity and facilitate other capabilities and features described herein, in accordance with various aspects of the subject innovation.

FIG. 2 illustrates a second example system that can incentivize physical activity in accordance with aspects of the innovation.

FIG. 3 illustrates one example of a motion component in accordance with aspects of the innovation.

FIG. 4 illustrates an example control component in accordance with aspects of the subject innovation, which, as shown therein, can comprise one or more optional sub-components.

FIG. 5 illustrates one embodiment of a method of incentivizing physical activity in accordance with aspects of the subject innovation.

FIG. 6 illustrates a block diagram of a computer operable to execute the disclosed architecture.

FIG. 7 illustrates a schematic block diagram of an exemplary computing environment in accordance with the subject innovation.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details. In other instances, well-known structures and devices are shown in block diagram form in order to facilitate describing the innovation.

As used in this application, the terms “component” and “system” are intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

As used herein, the term to “infer” or “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

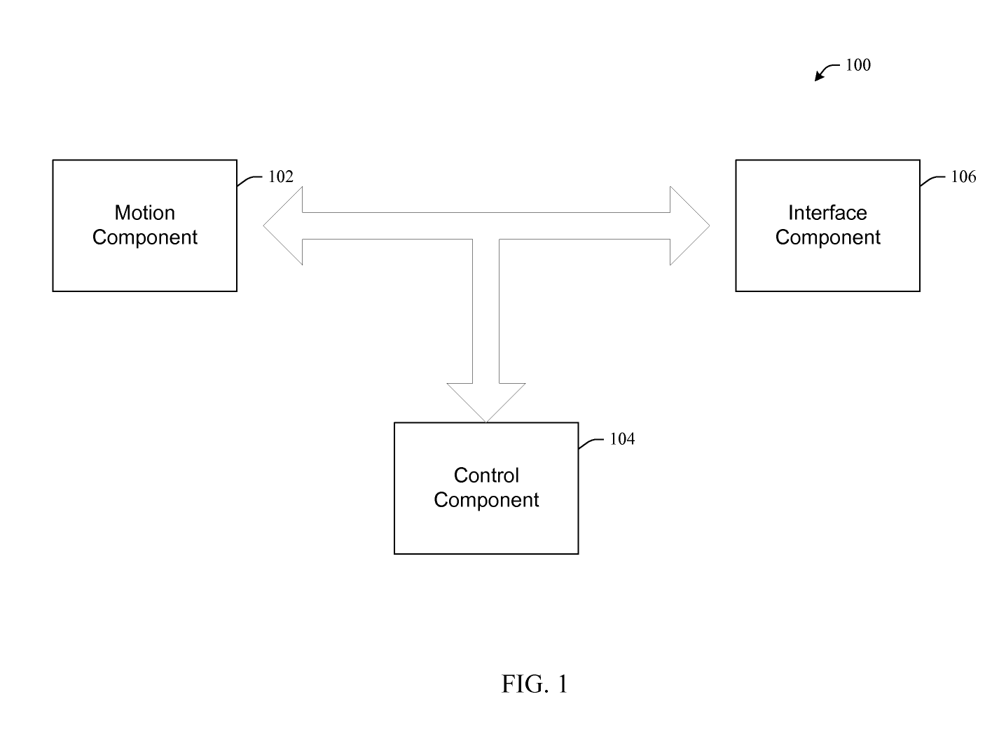

Referring initially to the drawings, FIG. 1 illustrates an example system 100 that incentivize physical activity and facilitate other capabilities and features described herein in accordance with various aspects of the subject innovation. System 100 can comprise a motion component 102 that can at least one of measure or monitor the motion (e.g., exercise, etc.) of a user of system 100, can include a control component 104 that can manage functions of or coordinate interaction with system 100, and can include an optional interface component 106 that can facilitate transferring data between motion component 102 and control component 104, such as to monitor motion data, for redeeming progress (e.g., accomplishments related to motion, etc.) for rewards (e.g., status designators, prizes, discounts, etc.) via a control component 104, etc. These rewards can include one or more of colored or patterned bands (e.g., in substantially any color, combination of colors, or pattern), cases, etc. for a motion component; downloadable files (e.g., music, apps, etc.) to a motion component or other device; retailer currency (e.g., points, tokens, store credit, etc. useable at an online or brick and mortar location, etc.); online redeemable currency (e.g., cash back rewards, online-only currency, etc.); virtual badges; reward currency redeemable either online or at one or more physical locations (e.g., via a proprietary docking station or wireless transfer using a unique identifier, etc.).

The movement measurable by motion component 102 need not be limited to just distance traveled, but can also include other motion, for example, substantially any motion of the user. This motion can be measured in increments of movement sometimes referred to herein as “motion unit(s),” which can have any of a variety of different scales (in some aspects, other terminology may also be used, such as distance equivalents, “steps,” etc.). In one aspect, motion units discussed herein can be equivalent to a distance approximately equal to the size of a step (e.g., at any of a variety of strides, such as walking, running, etc.), although other scales can be used (e.g., a distance equivalent to a unit of measure, such as mile-equivalents, etc.). In such an aspect, the step size can be an average step, or can be based on one or more factors (e.g., it can be based on age, gender, etc., can be based on a measured stride of an individual, etc.). Motion component 102 can also track motion historically, such as steps or motion units per day (or other period of time), total motion units or distance-equivalents (e.g., total “miles,” etc.).

Motion component 102 can additionally provide for at least one of upload or download of data to one or more of control component 104 or interface component 106. In various aspects, a motion component 102 of the subject innovation can store information necessary to access a secure website (e.g., that can be customized, customizable, etc.). In various aspects, motion component 102 can be associated with a user account maintained at least in part by control component 104, and the data can include data associated with the user, the user account, or both. As various examples, the data can include one or more measures of motion (e.g., total motion units by a user; a total over a given time period; a total since a given time, such as a total for the current day, week, etc.; a rate of motion per unit time; or other measures described herein); user information (e.g., an age of the user, identity, height, weight, gender, prior activity level, etc.); account settings (e.g., contact information, associated devices where more than one motion component is associated with an account, preferences such as whether or not to use location information or how to display information (e.g., distance, calories, etc.), etc.); as well as other information (e.g., historical information such as total usage or motion, trends, etc.). To preserve user privacy, any or all information can be on an “opt-in” basis to allow users to select whether and how much personal information to share, including the option of whether to share information in an anonymous manner if shared, etc.

Control component 104 can provide for any or all of a variety of capabilities. In one aspect, control component 104 can be maintained remotely (e.g., on one or more servers accessible via an Internet connection) and interface component 106 can provide for user interaction with control component 104 via any of a variety of means, such as a web page, an app on a mobile device, by connecting motion component 102 to a computer or other device with Internet access (e.g., wired or wirelessly, such as via USB, Bluetooth®, WiFi®, radio frequency identifier (RFID), etc.), or in other manners. Data uploaded from motion component 102 (e.g., data related to motion units, or other information discussed herein) can be associated with a user account by control component 104. Upload can occur on an intermittent or periodic (e.g., at least once weekly) basis. Control component 104 can present users with one or more of challenges or rewards associated with physical activity (which can be represented by motion units such as steps, distance-equivalents, etc.), as described further herein. In aspects, rewards can be redeemed via control component 104, such as in an online store through which a user can receive rewards in exchange for meeting challenges (such as any of those described herein). In some aspects, specific challenges can have specific rewards associated with them (e.g., specific rewards for meeting one or more lifetime motion totals, such as 25,000 steps, 10 mile-equivalents, etc.). Challenges can be based in any of a variety of ways on motion, such as total motion, peak motion rate, peak motion rate per unit time (e.g., minute, hour, etc.), average motion rate, average motion rate per unit time, average number of calories burned per day, etc., or other measures or metrics described herein. Additionally or alternatively, some or all challenges can be associated with a reward “currency” (tokens, etc.), such that a user that meets a given challenge receives a number of tokens associated with the challenge, wherein the reward currency can be redeemed via the store for one of a plurality of rewards, each associated with a price in terms of the reward currency. In various aspects, control component 104 and other portions of system 100 can be associated with an application programming interface (API) useable as an interface for communication between components of system 100.

In aspects, interface component 106 can provide an interface for interaction (e.g., user interaction, interaction of motion component 102, etc.) with control component 104 in any of a variety of manners, facilitating redemption of activity for rewards. In various examples, interface component 106 can be accessible via a computer (e.g., as a web portal, etc.), via an app on a mobile device, via a kiosk or other hardware device. Motion component 102 can communicate with interface component 106 (e.g., in a secure manner, to prevent fraud, such as that related to motion units, rewards, etc.) to exchange information with control component 104. Depending on the implementation of motion component 102 and the particular embodiment, interface component 106 and motion component 102 can interact via a wired (e.g., USB, etc.) or wireless (e.g., an 802.11 standard, Bluetooth®, etc.) connection. Various techniques can be implemented to discourage, catch, or prevent attempted fraud (e.g., one or more computer security protocols such as encrypting data, etc.; monitoring usage such as in motion steps to determine trends and spot suspicious information; associating each motion component with a unique identifier; etc.). In other examples, interface component 106 can additionally provide for interface (e.g., wired or wireless, etc.) with other devices. These other devices can include fitness equipment, which can interface with system 100 for a variety of reasons, such as to ensure transfer of and accurate measurement of exercise done with the fitness equipment. In other aspects, the functionality of one or more devices (e.g., television, game system, computer, etc.) can be partially unlocked based on communication with interface component 106, such as by allowing a certain amount of usage (e.g., time, data, etc.) based on motion recorded via motion component 102. In one example, exercising a certain amount (e.g., 10,000 step-equivalents, etc.) can unlock use of a device for a period of time (e.g., allowing use of a game system for an hour, etc.). In other aspects, however, access to the one or more devices can be accomplished via control component 104 (e.g., by associating the device with an account and allowing use of the device based on data associated with the account, such as with motion, challenges, etc.).

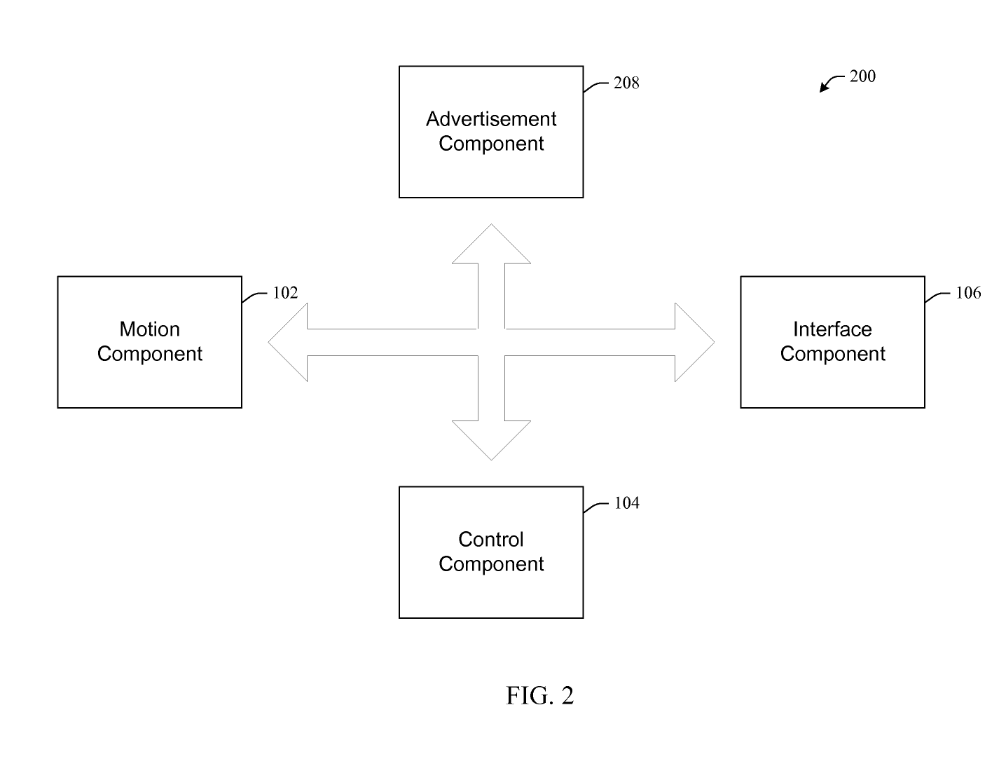

As seen in FIG. 2, in some embodiments, the innovation can comprise a system 200 that can incentivize physical activity in accordance with aspects of the innovation. System 200 can include a motion component 102, can include a control component 104, and can include an interface component 106, each of which can be substantially as described herein. Additionally, system 200 can comprise an advertisement component 208 that can present advertisements or offers to users of system 200. In some aspects, the advertisements or offers presented can be based on analysis of data associated with a user (e.g., to the extent that a user opts-in to making such information available, etc.), such as based on location information, analysis of trends (e.g., trends associated with the user, associated with other users based on one or more similarities between the other users and the user, such as age, location, interests of the user or other users, groups with which the user is associated (e.g., leagues, competitions, etc.), etc.), or other characteristics. In some embodiments, offers can be made available (e.g., as ongoing offers or limited time offers, on a repeatable basis or only for a limited number of times, etc.) in connection with challenges related to user activity (e.g., physical activity as measured in motion units, etc.). In some aspects, challenges can be associated with partnership opportunities. In one example, a product or service (e.g., fitness equipment, games, routines, etc.) of a partner can be associated with challenges of a system or method of the subject innovation, and rewards can be offered to incentivize use of the product or service of the partner. In other aspects, coupons, free samples, or other offers can be tied to user challenges. For example, users can be presented with an activity challenge (e.g., achieve a certain number of motion units in a given time period, a certain total level, a certain additional number by a given time, or variations based on the these, etc.), and upon meeting the challenge, can receive the associated offer (e.g., coupon, sample, deal, etc.). In one example, the nature of the challenge can be tailored to an activity level of the user (e.g., more active or younger users can be presented with a greater requirement than less active or older users such that the challenge remains comparably challenging for both groups, etc.) or independent of activity level, a location associated with the challenge (e.g., offering challenges associated with nearby locations, for example with a challenge comparable in motion steps or distance-equivalent to that obtainable by traveling to the location, whereby completion of the challenge can provide a reward (e.g., discount, coupon, buy one get one free or discounted, etc.) at a business at the location, etc.), or other factors described herein.

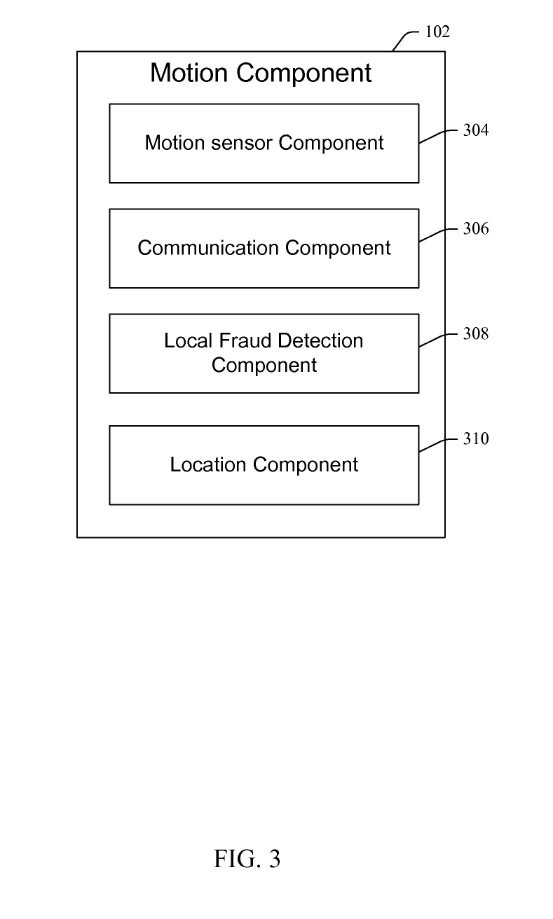

FIG. 3 shows one example of a motion component 102 in accordance with aspects of the innovation. As seen in FIG. 3, motion component 102 can comprise one or more optional components as described herein. Motion component 102 can comprise a motion sensor component 304, which can sense motion of the user. As the user moves, motion component 102 can be held, worn, carried, etc., such that motion of the user can be detected by motion sensor component 304. Motion sensor component 304 can be based at least in part on a tri-axis accelerometer (e.g., microelectromechanical system, etc) technology, such as a pedometer, etc. that can measure the motion of the user (e.g., in motion units, etc.). Additionally, motion component 102 can include a communication component 306 that can facilitate data exchange between motion component 102 and other components of a system. Communication component 306 can operate in a wired or wireless manner, and can provide for a secure connection between motion component 102 and other components of a system, such as to prevent fraud, preserve the security of information (e.g., personal information that a user opts to use in connection with the subject innovation, etc.). A local fraud detection component 308 can be included in motion component 102 to detect potential fraudulent activity. For example, motion that appears to be fraudulent for any of a variety of reasons (e.g., continuous for a longer than feasible or credible period of time, at rates that are unfeasible or not credible, etc.). Possibly fraudulent activity can be flagged for review, can prompt a challenge to a user to confirm that the activity should be recorded (which can take the form of a challenge and response, such as account authorization, to ensure activity is associated with only the user, and not others, etc.), can suspend recording until a user acknowledges that the activity is not fraudulent, etc. In aspects, motion component 102 can comprise a location component 310 that can determine a location (e.g., via the Global Positioning System, triangulation such as via cell towers, etc.) of motion component 102. Location data collected by location component 310 can be used in a variety of aspects in connection with systems and methods of the subject innovation. For example, distances traveled can be determined and associated with motion units, so as to provide additional feedback to users. Additionally, location data can be used to better tailor challenges, offers, etc., such as via targeted advertisements, information related to other users (e.g., those known to the user, on a team or in a league with the user, depending on what privacy options the user selects) who may also be exercising nearby (or to whom an invitation could be made via a system of the subject innovation, if a user wishes), and can provide other location-based information that may be of interest to the user, such as weather, traffic, etc. To preserve user privacy, any of these features can depend on whether users opt-in to make location data accessible to a system of the subject innovation, whether they select to share location data, which users or features they choose to share location data with, etc.

In some aspects, motion component 102 can comprise a mobile device (e.g., a smart phone, mobile phone, tablet computer, etc.) executing a software application (an “app”) as described further herein. In other aspects, motion component 102 can be a portable apparatus (e.g., wearable, able to be carried, etc.) comprising multiple components as described below. For example, motion component 102 can be implemented in a wearable embodiment (e.g., as a wrist-band, a clip, etc.) that can contain one or more of: (1) a motion sensor component (e.g., based on a tri-axis accelerometer (e.g., a microelectromechanical system, etc.) technology, such as a pedometer, etc.) 304 that can measure the motion of the user (e.g., in motion units, etc.), (2) a display (e.g., a liquid crystal display (LCD), light emitting diode (LED), organic LED (OLED), light-emitting electrochemical cell (LEC), etc.) that can present information related to capabilities described herein (e.g., storing motion units, motion in connection with time or elapsed time, user details, rewards, etc.), (3) a memory (e.g., NAND, serial, or one-time programmable (OTP) flash; random access memory (RAM), read-only memory (ROM), etc.) capable of storing information related to features described herein, (4) a power source (e.g., a battery, such as a rechargeable Li-polymer or other rechargeable battery, etc., a non-rechargeable battery, such as a watch battery, etc., a re-useable power source such as a photovoltaic cell, kinetic (e.g., with a self-winding rotor and piezoelectric quartz crystal as in an automatic quartz watch, etc.)) that can power the motion component 102, and other components. The other components can provide any of a variety of features to system 100 via motion component 102, such as timekeeping (e.g., via a watch, clock, etc.), location detection (e.g., via the Global Positioning System, triangulation such as via cell towers, etc.), and other features described herein. The wearable embodiment of motion component 102 can be carried by or attached to the user (or clothing, personal effects, etc.) (worn, clipped, etc.), and, in some embodiments, can be attached to a band or other wearable item to facilitate carrying of the wearable embodiment. Additionally, mobile device embodiments of motion component 102 can perform some or all (e.g., depending on the particulars of the mobile device implementing the app, etc.) of the capabilities described in connection with a wearable embodiment, as well as potentially other capabilities (e.g., browsing a web page associated with system 100, etc.).

As motion occurs, the motion sensor component (accelerometer, etc.) 304 can count the motion units (steps, etc.). A count of the motion units (e.g., total units, a total over a given period of time, since a given time, during the day, motion units per unit time, etc.) can be presented on the display. Additionally or alternatively, the display can be used for displaying other information (e.g., time, battery life, location information, etc.). Information associated with the counted motions units can also be stored in memory (e.g., step data, distance equivalent data, etc.), regardless of battery life. As will be understood, the innovation can enable lifetime storing of such data in memory regardless of power. In aspects with a rechargeable battery, the rechargeable battery can be recharged via a UBS connection, charger, charging pad, etc. In various aspects, the motion component 102 can have a standard USB connection, or can have a different (e.g., smaller, etc.) connection and a cable or other adapter can be provided to a user along with motion component 102.

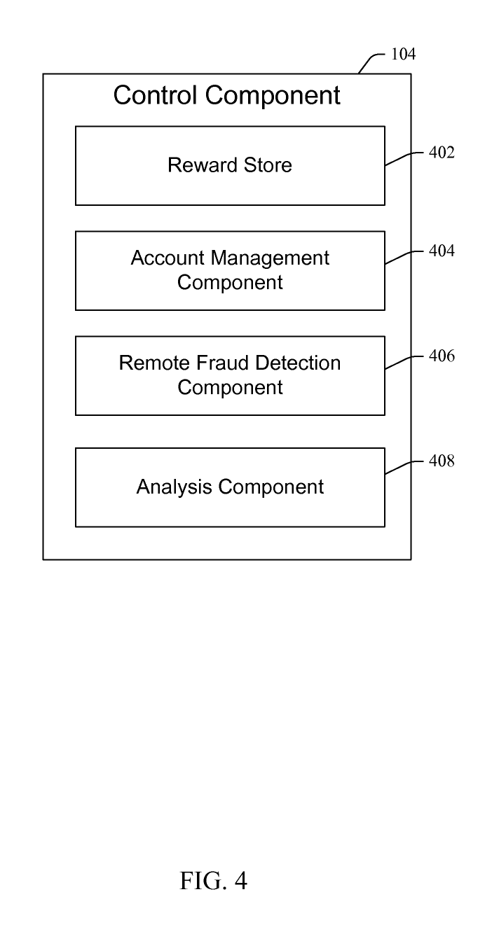

FIG. 4 illustrates an example control component 104, which, as shown therein, can comprise one or more optional sub-components. As shown in FIG. 4, control component 104 can comprise a reward store 402. In various aspects, reward store 402 can provide users with one or more rewards, which can be based at least in part on one or more of a variety of factors. In one example, physical activity (e.g., as measured by motion units, etc.) can trigger specific rewards (e.g., as various milestones are reached, target fitness levels, etc.), such as different colored or patterned bands to indicate various lifetime achievements, etc., or can provide choices of rewards (e.g., by providing multiple options, or by providing users a reward currency (e.g., tokens, etc.) redeemable for rewards, or both. In other examples, accomplishment of various challenges (e.g., individual, competitive, cooperative, or any combination thereof, etc.) can provide specific rewards, options among rewards, or reward currency (e.g., tokens, etc.). In other examples, completion of various programs, reaching a target fitness level (e.g., as measured by meeting a threshold level of activity over a time period, etc.), or combinations thereof, can trigger rewards similarly to those discussed above.

In various aspects, control component 104 can include an account management component 404. Account management component 404 can provide for user interaction with a user account, such as to monitor activity (e.g., by providing historical information showing how a user's activity level, such as measured by motion units, has progressed over time, etc.), to change account settings (e.g., what personal information a user opts to share, such as can be used to determine challenges, to match users in leagues or teams for competitive or cooperative activities, to target advertisements or offers, to set personal goals related to activity levels, etc.), to monitor challenges and activities (e.g., challenges which are available for the user to complete, completed challenges, etc.), rewards (e.g., those already received, those available, reward currency if any, etc.), social groups (e.g., other friends or users known to the user who also have accounts, competitive or cooperative groups, teams, or leagues in which the user is or can be participating, etc.), and other aspects.

Additionally, control component 104 can comprise a remote fraud detection component 406. Remote fraud detection component 104 can determine potentially fraudulent activity related to a system or method of the subject innovation. For example, activity levels well above what a user previously has done could be flagged as potentially fraudulent (e.g., for review, confirmation, or other action as discussed herein, etc.), as could activity for a period of time that does not appear likely based on past or expected user behavior (e.g., continuous motion for 24 hours, etc.). In other aspects, remote fraud detection component can implement security protocols to ensure that information transferred from a motion component 102 has not been tampered with (e.g., authenticating or error checking the data, etc.).

In some embodiments, control component 104 can comprises an analysis component capable of determining trends or patterns associated with one or more of users, motion data, rewards, challenges, or other aspects described herein. For example, in one embodiment, users can provide some biographical information (e.g., one or more of age, gender, weight, activity level, etc.; in one embodiment, only an age is used, etc.) from which a system or method of the subject innovation can determine a target activity level for the user (e.g., based on information related to other users, reference information related to health and fitness, etc.). In other aspects, a current activity level for a user can be learned by a user wearing or carrying a motion component 102 for a training period (e.g., one week, or more or less, etc.), during which the user can engage in a standard amount of motion or fitness activity (e.g., engaging in the same level of physical activity or lack thereof the user otherwise would, etc.), and a current activity level of the user can be learned. After the training period, the learned activity level can be used as a baseline level from which the user can build to develop a more active lifestyle. In such embodiments, analysis component 408 can determine one or more of the current activity level, as well as one or more target activity levels for the user. In other aspects, analysis component 408 can analyze one or more of current or historical activity levels for a user to suggest challenges determined to be appropriate to the user's activity level (e.g., a current or target level, etc.), to suggest competitive or cooperative groups in which a user can participate (which can also be based on other factors, including age, interests, location, times in which users engage in physical activities, etc.), or to determine rewards to provide users (e.g., to determine rewards commensurate to the challenge for that particular user, such that users of various activity levels are encouraged to meet individualized fitness targets to receive rewards, etc.).

As discussed above, in various aspects, users can participate in challenges associated with systems and methods of the subject innovation. These challenges can vary from simple (e.g., with a single requirement or stage) challenges to more complex challenges (e.g., with multiple requirements or stages, some of which can be optional or alternatives, or all of which can be required, etc.), and can be individual challenges (e.g., wherein a system or method of the subject innovation provides one or more users with individual requirements, even if some or all of the requirements are the same or different, etc.), or can be challenges with at least some social element (e.g., encouraging or requiring cooperation, competition, etc.). As examples of a cooperative challenge, each of a plurality of users might be required to each meet an individual fitness or physical activity requirement (which could be the same for each or tailored to each individual, etc.), at which point each of the plurality of users would receive a reward (possibly in addition to or instead of rewards for individual accomplishments, etc.), or the plurality of users might be required to meet a collective goal (e.g., some requisite number of total motion units for a group such that some or all members of the plurality could contribute to it, which could be weighted based on individualized requirements, such as by weighting activity by users with a lower activity level higher, etc.). As examples of a competitive challenge, a plurality of users can compete against each other (acting individually or in two or more teams), such that rewards (which may be the only rewards or may be additional rewards) are provided to users based on how they performed relative to other users (e.g., whether they achieved a relatively higher or lower number of motion units in a given time frame, or a greater percentage relative to an individual target amount, etc.). Some challenges can incorporate both cooperative and competitive social elements. In cooperative or competitive settings, users can be grouped based on any of a variety of characteristics, such as user choice (selecting a group, such as friends, etc.), based on demographic information (e.g., grouped with users similar in one or more ways, such as age, gender, interests, location (e.g., the same city, etc.), activity level, weight, times during which users exercise (e.g., as determined by trend analysis of motion data, etc.), etc.).

Additionally, participation in physical activity via the system can be incentivized in other ways. In some aspects, a user can be provided a reward for meeting a threshold target of physical activity for a given time period, or can receive a chance to obtain a reward (e.g., which can be randomly given among users meeting a given threshold). Such rewards can also be based on completion of challenges, such as a given number of challenges in a time period (additionally or alternatively, the odds or number of “entries” can be increased based on or proportional to a number of challenges completed in a time period, such as a day, week, month, etc.). In other aspects, lifetime progress can be measured and incentivized by providing users rewards as various goals are met, such as a total number of motion units, meeting a target number of motion units for several consecutive time periods or a threshold percentage of time periods (e.g., meeting a target for four straight weeks, etc.).

While, for purposes of simplicity of explanation, the one or more methodologies shown herein, e.g., in the form of a flow chart, are shown and described as a series of acts, it is to be understood and appreciated that the subject innovation is not limited by the order of acts, as some acts may, in accordance with the innovation, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

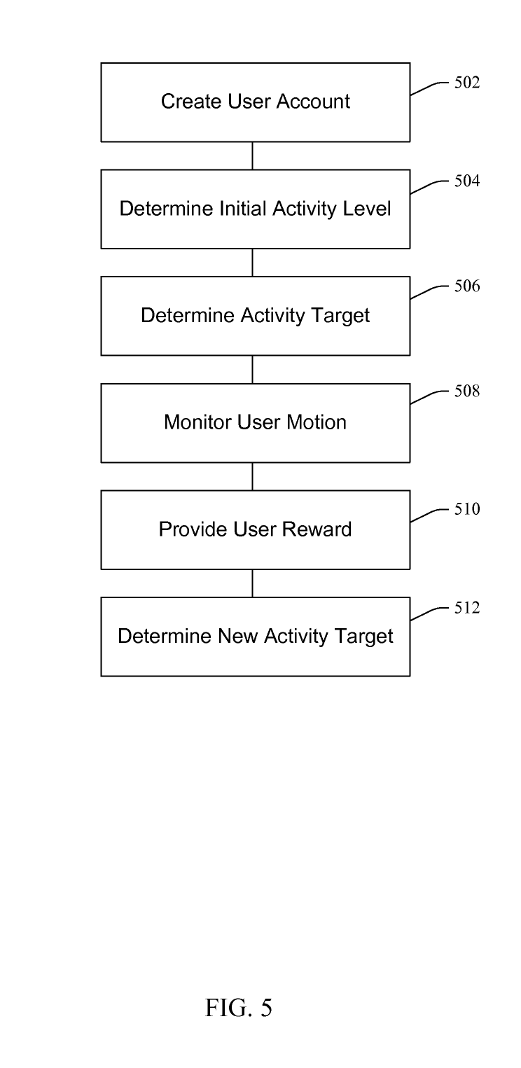

Returning to the discussion of the figures, FIG. 5 illustrates one embodiment of a method of incentivizing physical activity in accordance with aspects of the subject innovation. At step 502, the method can begin with creating a user account. In creating the user account, one or more motion components can be associated with the user account (e.g., a wearable motion component as described herein, a mobile device implementing an app, etc.). In aspects wherein a user account is associated with more than one motion component, one motion component at a time can be designated as an active motion component, or an average value of multiple active motion components can be used as an estimate of user activity level (e.g., as measured in motion units, etc.), or multiple options can be presented (e.g., to allow user selection, etc.).

At step 504, an initial activity level of the user can be determined. In various aspects, as described herein, a user can (e.g., at the user's option) provide user information in connection with creating or updating a user account, such as age, gender, weight, etc., and based at least in part on the provided information, the initial activity level can be determined. In some aspects, the initial activity level can be determined based at least in part on monitoring user activity during a training or learning period.

At step 506, one or more activity targets can be determined based at least in part on one or more factors, including: user selections (e.g., personal goals, etc.), the initial activity level, default values (e.g., target milestones, target motion units per day, etc.), tailored values (e.g., tailored based on user criteria, learned activity level, etc.), community activity information (e.g., in competitive or cooperative activities, a goal may be based on meeting or exceeding a value determined based at least in part on the activity of one or more other users, etc.), etc.

The method can continue at step 508, wherein motion of the user can be monitored. This monitoring can occur periodically or continuously. For example, as described herein, the monitoring can comprise periodic receipt by a control component of motion data (e.g., motion units, etc.) captured by a motion component or similar device. User activity can continue to be monitored until the user meets at least one activity target.

At step 510, the method can further include a step of providing a user with a reward associated with the activity target based on the user meeting the target. As described herein, the reward can be specific to the target, or can provide several options to a user for choice of reward, or can comprise some form of reward currency (e.g., tokens, credit at an online or “brick and mortar” store or retailer, etc.) that can be redeemed by a user at a reward store for a choice of rewards (e.g., user-selectable rewards from among a specific selection, or useable at an online retailer, etc.). In various aspects, rewards can include one or more of local rewards (e.g., associated with a particular organization associated with the user or method, with local partners associated with the method, etc.) or universal rewards (e.g., status indicators, reward currency, etc.).

Additionally, at step 512, a new activity target can be determined for the user. The target can be based on one or more of a variety of factors, such as: default targets (e.g., lifetime motion unit targets, such as certain milestones like 25,000, 50,000, or 75,000 motion units, etc.), personalized targets (e.g., based on the initial activity level of the user, a current activity level, various biographical information, etc.), one or more previous activity targets (e.g., to maintain or increase an activity level, etc.), various community information (e.g., competitive or cooperative targets based at least in part on one or more other users, etc.), or other factors.

Furthermore, although not all of the foregoing steps are required, methods of the subject innovation can also include multiple optional steps, such as would be apparent based on the functions of various components described herein. For example, a method of the subject innovation could further include determining and/or providing one or more advertisements or offers to a user, which could be based on user information that can be optionally provided by a user (e.g., interests, activity level, location, etc.). Additionally, in other aspects, methods could include determining a current activity level of the user, to determine challenges or activity targets, etc. In another example, the method can comprise determining one or more competitive or cooperative groups, teams, or leagues to offer to a user for participation therein, which can be based on analysis of user information, based on user input (e.g., searching for friends associated with the system, etc.), user activity level, etc.

In one aspect, systems and methods of the subject innovation can be used in connection with a school or other organization, such as a youth program, fundraising group, charity, etc. For example, one or more motion components (or an app, etc.) can be given to schools, etc., possibly in exchange for a promise to provide a portion (e.g., an initial portion, etc.) of money raised so as to defray the cost of the motion component, etc. In a next step, the school or other organization can promote an organizational challenge in connection with a system or method of the subject innovation, which can be used for fundraising. The organizational challenge can be of variable or fixed duration (e.g., based on achieving an activity target in a fixed duration, trying to achieve an activity target in as short a time as possible, trying to maximize activity in a fixed period of time, etc.). In one example, the organizational challenge can be a 21 day (or other fixed period) challenge to reach some set distance-equivalent target (e.g., 100 mile-equivalents, etc.) and raise some sum of money (e.g., for the school's wellness initiative, etc., based on community sponsorship, etc.). During the organizational challenge, the participants (e.g., kids, etc.) can have some method of monitoring progress, such as a tracking poster, a classroom tracking poster, individual or organizational web pages, etc. The tracked motion data can feed to one or more of databases or a website associated with the subject innovation, social media programs, etc.

In aspects, one or more challenge posters can be provided to the organization or participants in connection with the organizational challenge to monitor progress of the organization or participants. In aspects, the organization can be provided with multiple materials, such as in a challenge “kit,” which can include: motion components, instructional materials (e.g., user guide, challenge guidelines, etc.), fundraising forms, personal tracking materials (e.g., personal posters, which in an embodiment for use in schools can be sized to fit in a locker, etc.), a charger or cord to recharge the motion component if necessary, and possibly other materials.

In some embodiments wherein one or more persons operate in a supervisory capacity (e.g., teachers in an embodiment related to schools, or other leadership or designated persons in various other organizations, etc.), supervisory persons can receive a supervisory “kit,” which can contain the same materials as in the standard challenge kit, and can additionally include one or more organizational posters (e.g., classroom, etc.) and one or more reward items (e.g., different colored or patterned bands for a wearable motion component, to designate different milestones of accomplishment, etc.).

As described herein, systems and methods of the subject innovation can implement or include one or more algorithms or components for detecting potential fraud. For example, these can include a means to detect cheating in aggregating steps (e.g., continuous movement for 18 hours, continuous “running” movement for 6 hours, more than 150K steps per day, etc).

Additionally, rewards can include other attachable features that can slip over or attach to a wearable motion component or band to allow for customization. Such rewards can be included as incentives for an organizational challenge in accordance with various aspects of the subject innovation. For example, for each 25 miles earned (or for other milestones or achievements, etc.), participants can receive from a supervisor or program administrator a different attachable feature (e.g., ringlet, etc.), and participants can use one or more attachable features in connection with a single embodiment of the subject innovation.

One or more fraud detection components or method steps can learn behavior, such as by analyzing movement data, comparing to known behavior data, and detecting potential fraud based upon the comparison. If potential fraud is detected—an indicator can be applied to a record or presented on a motion component to indicate some level of questionability or potential fraud associated with the activity. In aspects, the fraud detection techniques can employ a challenge/response—for example, a series of questions can be asked and answered which can then be compared to the trend movement data to establish if fraud was committed or if the data is likely true and accurate data.

Various analysis described herein (e.g., to determine trends, to match users, to determine activity levels, to design or provide challenges, etc.) can employ rules based or machine learning algorithms. For example, the subject innovation can employ various AI-based schemes for carrying out various aspects thereof. For example, a process for determining appropriate user activity targets can be facilitated via an automatic classifier system and process.

A classifier is a function that maps an input attribute vector, x=(x₁, x₂, x₃, x₄, xₙ), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. In the case of determining appropriate activity targets, for example, attributes can include prior user activity levels, user biographical information (e.g., age, weight, etc.), etc., and the classes can relate to various activity levels, as represented in any of a variety of ways (e.g., total lifetime target, daily targets, rates, etc.).

A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated from the subject specification, the subject innovation can employ classifiers that are explicitly trained (e.g., via a generic training data) as well as implicitly trained (e.g., via observing user behavior, receiving extrinsic information). For example, SVM's are configured via a learning or training phase within a classifier constructor and feature selection module. Thus, the classifier(s) can be used to automatically learn and perform a number of functions, including but not limited to determining according to predetermined criteria one or more of: rewards commensurate to how challenging an activity is to a particular user (e.g., based on comparable users, etc.); matching users in competitive or cooperative groups, teams, or leagues; determining potential fraud; etc.

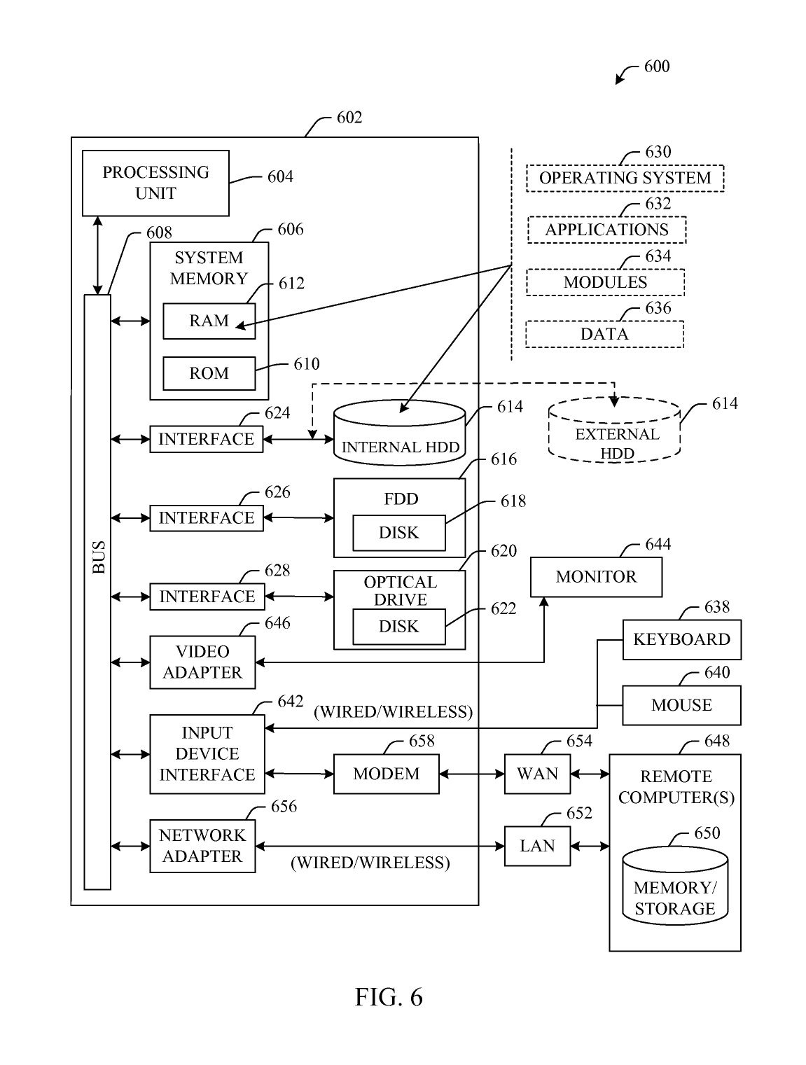

Referring now to FIG. 6, there is illustrated a block diagram of a computer operable to execute the disclosed architecture. In order to provide additional context for various aspects of the subject innovation, FIG. 6 and the following discussion are intended to provide a brief, general description of a suitable computing environment 600 in which the various aspects of the innovation can be implemented. While the innovation has been described above in the general context of computer-executable instructions that may run on one or more computers, those skilled in the art will recognize that the innovation also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 6, the exemplary environment 600 for implementing various aspects of the innovation includes a computer 602, the computer 602 including a processing unit 604, a system memory 606 and a system bus 608. The system bus 608 couples system components including, but not limited to, the system memory 606 to the processing unit 604. The processing unit 604 can be any of various commercially available processors. Dual microprocessors and other multi-processor architectures may also be employed as the processing unit 604.

The system bus 608 can be any of several types of bus structure that may further interconnect to a memory bus (with or without a memory controller), a peripheral bus, and a local bus using any of a variety of commercially available bus architectures. The system memory 606 includes read-only memory (ROM) 610 and random access memory (RAM) 612. A basic input/output system (BIOS) is stored in a non-volatile memory 610 such as ROM, EPROM, EEPROM, which BIOS contains the basic routines that help to transfer information between elements within the computer 602, such as during start-up. The RAM 612 can also include a high-speed RAM such as static RAM for caching data.

The computer 602 further includes an internal hard disk drive (HDD) 614 (e.g., EIDE, SATA), which internal hard disk drive 614 may also be configured for external use in a suitable chassis (not shown), a magnetic floppy disk drive (FDD) 616, (e.g., to read from or write to a removable diskette 618) and an optical disk drive 620, (e.g., reading a CD-ROM disk 622 or, to read from or write to other high capacity optical media such as the DVD). The hard disk drive 614, magnetic disk drive 616 and optical disk drive 620 can be connected to the system bus 608 by a hard disk drive interface 624, a magnetic disk drive interface 626 and an optical drive interface 628, respectively. The interface 624 for external drive implementations includes at least one or both of Universal Serial Bus (USB) and IEEE 1394 interface technologies. Other external drive connection technologies are within contemplation of the subject innovation.

The drives and their associated computer-readable media provide nonvolatile storage of data, data structures, computer-executable instructions, and so forth. For the computer 602, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the innovation.

A number of program modules can be stored in the drives and RAM 612, including an operating system 630, one or more application programs 632, other program modules 634 and program data 636. All or portions of the operating system, applications, modules, and/or data can also be cached in the RAM 612. It is appreciated that the innovation can be implemented with various commercially available operating systems or combinations of operating systems.

A user can enter commands and information into the computer 602 through one or more wired/wireless input devices, e.g., a keyboard 638 and a pointing device, such as a mouse 640. Other input devices (not shown) may include a microphone, an IR remote control, a joystick, a game pad, a stylus pen, touch screen, or the like. These and other input devices are often connected to the processing unit 604 through an input device interface 642 that is coupled to the system bus 608, but can be connected by other interfaces, such as a parallel port, an IEEE 1394 serial port, a game port, a USB port, an IR interface, etc.

A monitor 644 or other type of display device is also connected to the system bus 608 via an interface, such as a video adapter 646. In addition to the monitor 644, a computer typically includes other peripheral output devices (not shown), such as speakers, printers, etc.

The computer 602 may operate in a networked environment using logical connections via wired and/or wireless communications to one or more remote computers, such as a remote computer(s) 648. The remote computer(s) 648 can be a workstation, a server computer, a router, a personal computer, portable computer, microprocessor-based entertainment appliance, a peer device or other common network node, and typically includes many or all of the elements described relative to the computer 602, although, for purposes of brevity, only a memory/storage device 650 is illustrated. The logical connections depicted include wired/wireless connectivity to a local area network (LAN) 652 and/or larger networks, e.g., a wide area network (WAN) 654. Such LAN and WAN networking environments are commonplace in offices and companies, and facilitate enterprise-wide computer networks, such as intranets, all of which may connect to a global communications network, e.g., the Internet.

When used in a LAN networking environment, the computer 602 is connected to the local network 652 through a wired and/or wireless communication network interface or adapter 656. The adapter 656 may facilitate wired or wireless communication to the LAN 652, which may also include a wireless access point disposed thereon for communicating with the wireless adapter 656.

When used in a WAN networking environment, the computer 602 can include a modem 658, or is connected to a communications server on the WAN 654, or has other means for establishing communications over the WAN 654, such as by way of the Internet. The modem 658, which can be internal or external and a wired or wireless device, is connected to the system bus 608 via the serial port interface 642. In a networked environment, program modules depicted relative to the computer 602, or portions thereof, can be stored in the remote memory/storage device 650. It will be appreciated that the network connections shown are exemplary and other means of establishing a communications link between the computers can be used.

The computer 602 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10 BaseT wired Ethernet networks used in many offices.

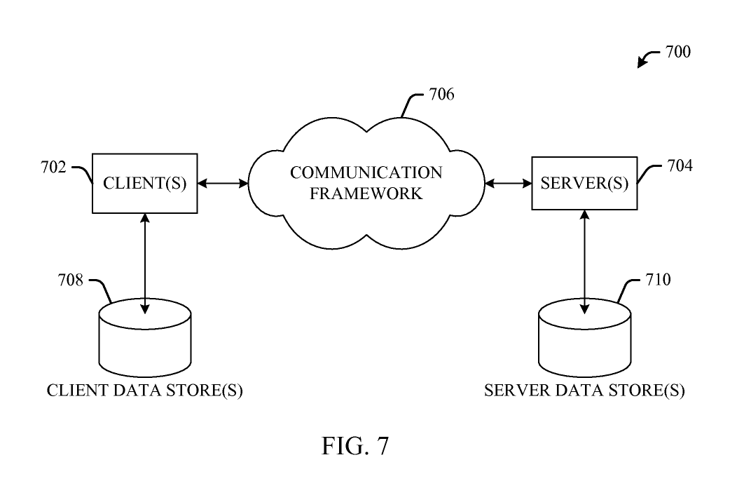

Referring now to FIG. 7, there is illustrated a schematic block diagram of an exemplary computing environment 700 in accordance with the subject innovation. The system 700 includes one or more client(s) 702. The client(s) 702 can be hardware and/or software (e.g., threads, processes, computing devices). The client(s) 702 can house cookie(s) and/or associated contextual information by employing the innovation, for example.

The system 700 also includes one or more server(s) 704. The server(s) 704 can also be hardware and/or software (e.g., threads, processes, computing devices). The servers 704 can house threads to perform transformations by employing the innovation, for example. One possible communication between a client 702 and a server 704 can be in the form of a data packet adapted to be transmitted between two or more computer processes. The data packet may include a cookie and/or associated contextual information, for example. The system 700 includes a communication framework 706 (e.g., a global communication network such as the Internet) that can be employed to facilitate communications between the client(s) 702 and the server(s) 704.

Communications can be facilitated via a wired (including optical fiber) and/or wireless technology. The client(s) 702 are operatively connected to one or more client data store(s) 708 that can be employed to store information local to the client(s) 702 (e.g., cookie(s) and/or associated contextual information). Similarly, the server(s) 704 are operatively connected to one or more server data store(s) 710 that can be employed to store information local to the servers 704.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system that incentivizes physical fitness of a user, comprising:
a motion component that monitors motion data associated with the user; and
a control component that provides one or more rewards to the user, wherein the rewards are based at least in part on the user meeting a target associated with the motion data.

2. The system of claim 1, further comprising an interface component that provides for communication of the motion data from the motion component to the control component.

3. The system of claim 1, wherein the motion data represents motion of the user in steps.

4. The system of claim 1, further comprising an advertisement component that provides the user with at least one of an advertisement or an offer associated with the motion data.

5. The system of claim 4, wherein the at least one of the advertisement or the offer is based at least in part on analysis of personal data associated with the user.

6. The system of claim 1, wherein the motion component further comprises a location component that determines location data of the user and associates the motion data with the location data of the user.

7. The system of claim 1, wherein the motion component further comprises a local fraud detection component that monitors the motion data to determine whether some or all of the motion data is potentially fraudulent.

8. The system of claim 1, wherein the target is associated with one or more challenges presented to the user.

9. The system of claim 8, wherein the target is based at least in part on community information that comprises motion data of one or more other users.

10. The system of claim 1, wherein the control component comprises an analysis component that determines the target based at least in part on biographical information associated with the user.

11. The system of claim 1, wherein the control component comprises an analysis component that determines the target based at least in part on an activity level of the user as measured during a training period.

12. The system of claim 1, wherein the control component comprises a reward store, and the one or more rewards are selected by the user from among a plurality of potential rewards offered via the reward store.

13. A method of facilitating physical activity of a user, comprising:
creating a user account;
determining an activity target of the user;
monitoring user motion until the user meets the activity target; and
providing the user a reward based at least in part on meeting the activity target.

14. The method of claim 13, further comprising determining an initial activity level of the user, wherein the activity target is based at least in part on the initial activity level.

15. The method of claim 14, wherein the initial activity level of the user is based at least in part on one or more of an age of the user, activity data monitored during a training period, fitness information supplied by the user, or a weight of the user.

16. The method of claim 13, further comprising determining a new activity target based at least in part on the activity target met by the user.

17. The method of claim 13, wherein the activity target is based at least in part on community information associated with one or more other users.

18. The method of claim 13, further comprising inspecting user motion to prevent entry of potentially fraudulent information.

19. The method of claim 13, wherein providing the user the reward comprises providing the user with a quantity of reward currency redeemable for one or more user-selectable rewards.

20. A method of incentivizing activity in an organization, comprising:
determining a set of participants;
assigning a fitness target to the set of participants;
monitoring the progress of the participants relative to the fitness target; and
providing one or more rewards to the participants based on meeting one or more checkpoints associated with the fitness target.
